(19) United States
(12) Patent Application Publication
(10) Pub. No.: US 2010/0019547 A1
(43) Pub. Date: Jan. 28, 2010

(54) Car Seat with Rolling Wheels and Method to use

(76) Inventors: Melissa Gray, Fernandina Beach, FL (US); Joseph Gray, Fernandina beach, FL (US)

Correspondence Address: LAW OFFICE OF L. JACK GIBNEY, 8777 SAN JOSE BLVD., SUITE 502, JACKSONVILLE, FL, 32217, US

(21) Appl. No.: 12/570,574

(22) Filed: Sep. 30, 2009

Related U.S. Application Data
(63) Continuation-in-part of application No. 11/873,766, filed on Oct. 17, 2007.

(51) Int. Cl. A47D 1/06; A47C 13/00; A47D 11/00; B62B 7/02

(52) U.S. Cl. 297/118; 280/30

(57) ABSTRACT

This invention is a car seat, which can be easily converted into a stroller by extending a stroller handle and tilting the car seat backwards until a pair of wheels contacts the ground. A pair of wheels is placed on the back surface of the car seat to convert the car seat into a stroller, if and when necessary. and a separate handle will be used to enable the user to tilt the car seat so that the device can be rolled.

### RELATED APPLICATIONS

This application is a continuation in part of a prior filed application with Ser. No. 11/873,766 and a filing date of Oct. 17, 2007.

### BACKGROUND OF THE INVENTION

A. Field of the Invention

This relates to transporting children in car seats and having an adaptable, portable car seat that will tilt backwards and roll. The car seat will easily fit into the base for a car seat and can also be easily placed into a stroller as well.

B. Prior Art

There are many other prior art references to strollers in general, including wheeled car seats. A representative example of this type of device can be found at King, U.S. Pat. No. 6,976,685. This is a wheeled car seat, which has a telescoping handle. Another representative example of this type of device is Birchfield, U.S. Pat. No. 7,090,291. This is a combination child vehicle seat and temporary stroller in which a plurality of roller wheels are placed on the bottom surface of the device.

There are other foldable strollers and a representative example of this can be found at Lieng, U.S. Pat. No. 6,398,233. This is a device in which the car seat can be placed in a stroller. Many other types of this device can be found in the prior art.

Another example of a stroller with a car seat passenger arrangement is Agsia, U.S. Pat. No. 6,923,467. Again, this type of device can be found in the prior art.

In previous Office Actions the examiner has cited Cote US publication number 2002/0060444, Bischoff U.S. Pat. No. 6,938,915 and Qureshi U.S. Pat. No. 4,989,888 as teaching some of the features of the present application.

The Qureshi reference teaches a pair of wheels in the front and the back of the unit that are stowed under the bottom of the device and rotate outward to rest on the ground surface. In the current application a pair of wheels is attached to the back surface of the bottom of the car seat. The current application would prevent the rolling of the device.

The Cote reference teaches a pair of wheels that extend outward in the front of the device. In order to operate the device in Cote the person would need to lift the handle and push or pull the seat. In the current application the person tilts the car seat to engage the wheels. The Cote reference addresses the concern of inadvertent rolling but makes it difficult to operate because of the physical requirement to lift the handle.

The Bischoff reference teaches a car seat with a base that is placed on the seat of an automobile. This reference teaches a pair of wheels that are attached to the back surface of the device and the car seat is tilted and this allows the car seat to be pushed or pulled. The arrangement of the wheels is similar in this case although the wheels in the current application are housed in cavities for that purpose.

The applicant would concede that there are multitudes of devices that act as car seats for infants and a great many of these devices will fit within the structure of a stroller. With this application the car seat will fit on a base that is commonly used with car seat and fit within the structure of a stroller but will also have the capability to roll when desired by the parent.

### BRIEF SUMMARY OF THE INVENTION

This is a standard infant car seat, which has been modified so that it can be converted into a wheeled stroller, if and when needed. The basic structure of the device is an infant car seat that fits within a base that is commonly used with a car seat of this type. The car seat will also be equipped with a handle that allows the parent to carry the child in the car seat while strapped into the seat. The car seat handle is allowed to rotate but typically does not telescope.

In this application a set of wheels is placed on the back outside surface of the car seat and secured to the structure of the car seat. A separate stroller handle that will telescope is installed on this device, probably on the existing car seat handle. In order to accommodate the space limitations in most cars and trucks the stroller handle will rest flush against the top surface of the car seat handle when not employed. With this device the parent can simply extend the telescoping handle and tilt the seat backwards to engage the wheels so that the device can be pushed or pulled over the ground.

This tilting feature will enable the wheels to touch the ground and the parent can simply pull or push the child while the child is strapped to the interior of the car seat. When the car seat is in the upright position the wheels will not touch the ground and this eliminates any chance that the seat will be accidentally bumped and move. Additionally a means to brake the car seat when the car seat is upright on the ground will also be provided for additional safety.

This device will be used like most other infant car seats. A base unit is typically inserted in the car and the car seat locks onto the base. The bases that are sold today are equipped with an ability to lock directly onto the car seat and the infant car seat is secured to the base using a set a hooks on the bottom of the car seat for that purpose. The base unit may need to be modified to accommodate the wheels that will protrude slightly from the back surface of the car seat.

When the device is used, the parent simply removes the car seat from the car by grabbing the car seat handle and places the car seat on the ground. The parent then grabs the stroller handle and pulls it upward and tilts the car seat back so that the wheels contact the ground. Once the wheels contact the ground, this will allow the car seat to be pushed or pulled.

Most existing car seat can be moved from a car to a separate stroller. This car seat can also be placed in a typical stroller, and the device will be able to be locked in place without any modification to the stroller or the car seat.

### BRIEF DESCRIPTION OF THE DRAWINGS

FIG. 1 is a side view of the car seat and the base.

FIG. 2 is a back view of the car seat and the base.

FIG. 3 is a back view of the car seat and the base showing an alternative stroller handle placement.

FIG. 4 is a side view of the car seat and the base showing an alternative stroller handle placement.

FIG. 5 is a front view of the car seat.

FIG. 6 is a front view of the car seat showing an alternative handle placement.

FIG. 7 is a side view of the car seat and a stroller.

FIG. 8 is an in use view.

### DETAILED DESCRIPTION OF THE EMBODIMENTS

This is a combination infant car seat and stroller device 5. The device will take the general shape of an infant car seat 15, which is commonly found in the prior art. The child is placed in the interior of the top surface of the car seat and is secured within the structure of the car seat.

The infant car seat will have a car seat handle 8, which is connected to a portion of the infant car seat. The car seat handle is generally one piece with two sides and a top portion which connects the sides; this handle extends above the device and rotates across the top of the seat. The car seat handle is common with most infant car seats and allows the car seat to be carried by the parent. The car seat handle does not telescope and is used to lift the seat into the car, with or without the child, and to carry the child in the car seat, if and when necessary.

A stroller handle 10 will be connected to the car seat handle. The stroller handle may be connected using the same connection means as the car seat handle or may be connected to the car seat handle along the edge or within a cavity in the car seat handle. The stroller handle will telescope for the comfort of the user of the device but when not employed will lie flush against the top surface of the car seat handle when it is not extended. The stroller handle should remain flush against the car seat handle in order to accommodate the space considerations of most cars and trucks. Additionally a means to lock the stroller handle in place when extended may also be provided. No specific means to lock the stroller handle is being claimed in this application.

The underside of this device will have the same basic structure as an infant car seat. A pair of wheels 20 will be placed on the back side of the car seat such that the wheels will not touch the ground when the car seat is in the upright position. The wheels are in a cavity on the back surface of the car seat and will be connected to a securing means 25 such as a pin or axle within the cavity provided for the wheel.

Regardless of the specific securing means the means must allow the wheels to rotate while in the cavities that are provided for that purpose. When the car seat is flat on the ground no part of the wheels will touch the ground to prevent the car seat from accidentally moving if the car seat is placed on a hill or accidentally bumped by a person. As an added safety feature a stop mechanism or brake 35 may be employed so that the seat will not move while the car seat is positioned upright and flat on the ground. A variety of brakes 35 can be used but the purpose of the brake is to insure that the wheels do not move. The brake 35 is attached to the axle that secures the wheels and rotates downward to lock the wheel in place.

The brake 35 is simply rotated by a parent's foot to make contact with the wheel 20; this insures that the wheel 20 and the car seat with the baby will not move.

Most infant car seats use a base 30. The base 30 is secured to the automobile and rests of the top of the seat in the car. The infant car seat will lock into place on the base and the base is secured to the seat using a seat belt either as part of the base or as part of the vehicle's equipment. This type of structure is common in the prior art. In order not to interfere with the operation of placing the car seat onto the base and removing the car seat from the base, the wheels will be recessed slightly. Alternatively there may be some need to modify the base in order to accommodate the wheels.

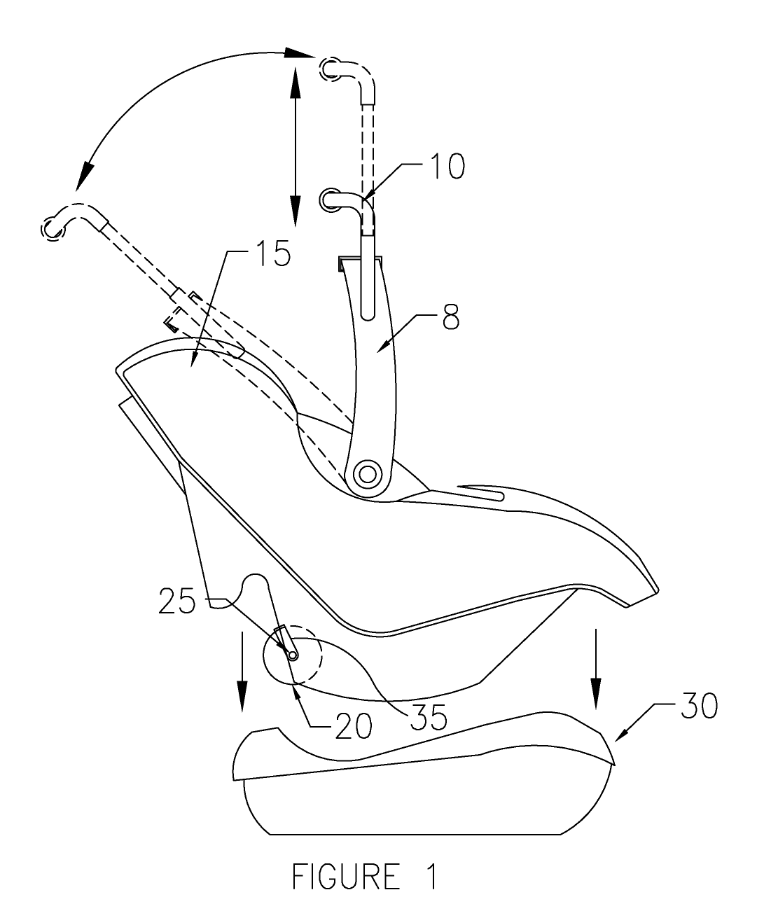

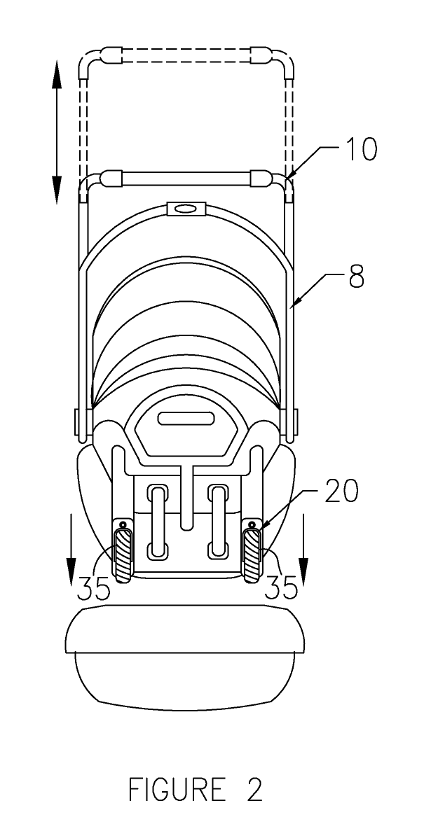

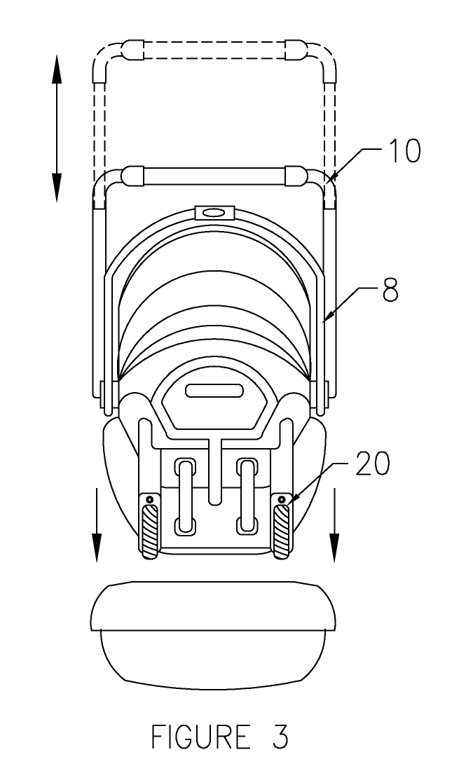

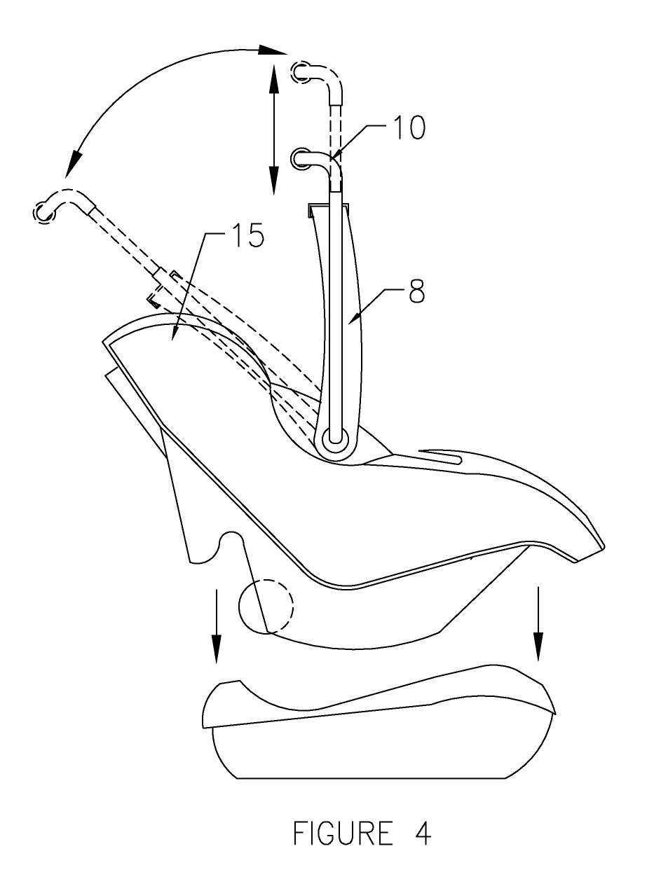

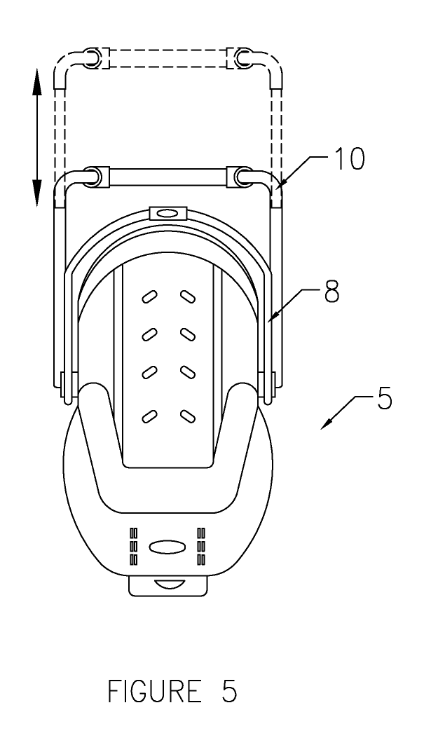

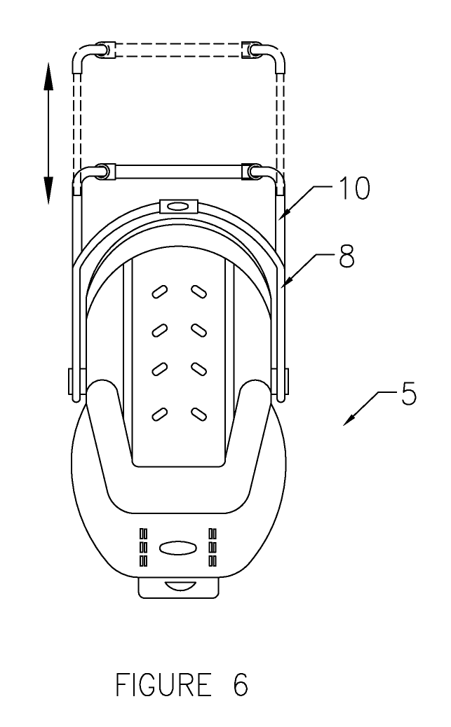

When the device is to be used the car seat is removed from the base and the parent removes the car seat from the car by grabbing the car seat handle and placing the car seat on the ground. The stroller handle is then extended to a predetermined height and the car seat is tilted backwards until the wheels touch the ground. The parent can push or pull the car seat using the stroller handle as depicted in FIG. 1. When the parent reaches the destination and no longer needs to use the stroller feature, the car seat will be placed flat on the ground and the stroller handle is moved downward and placed flush against the top surface of the car seat handle.

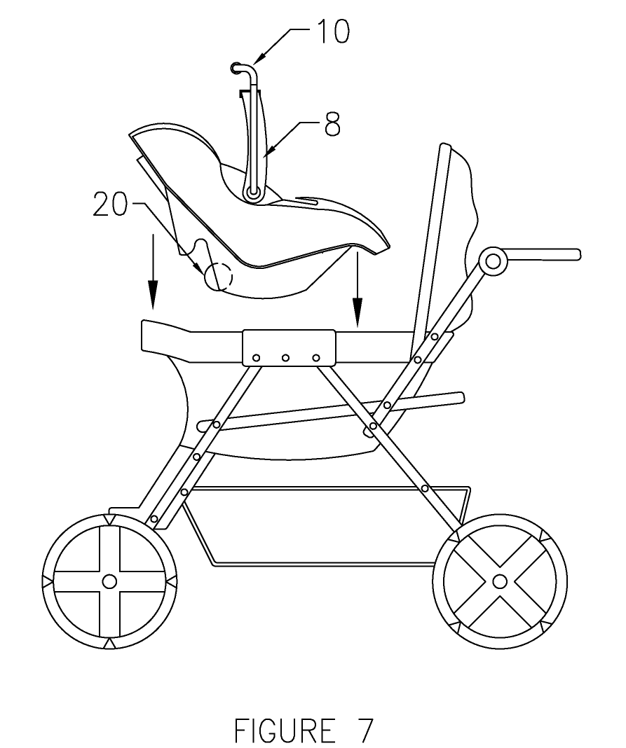

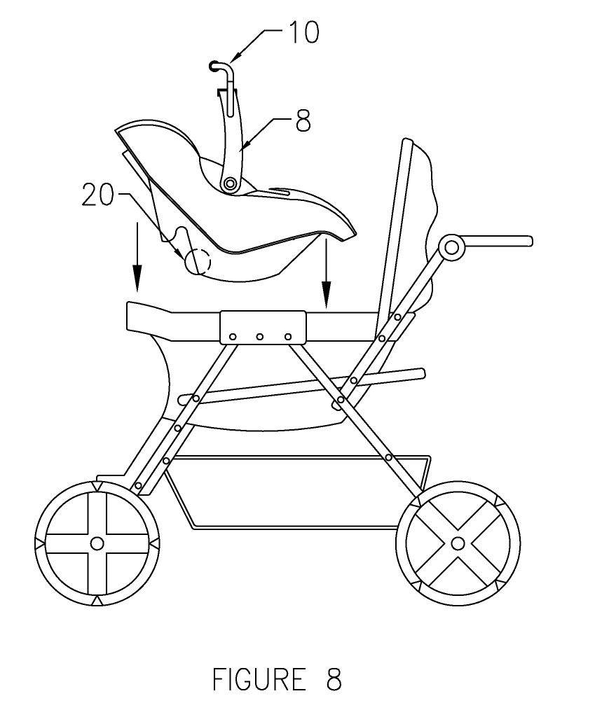

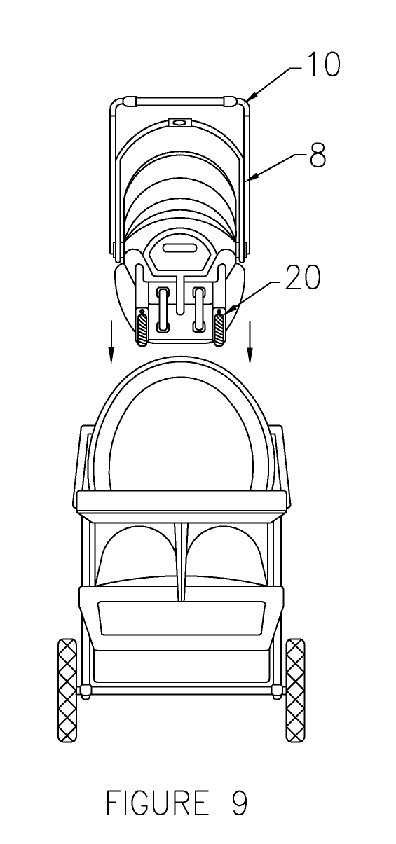

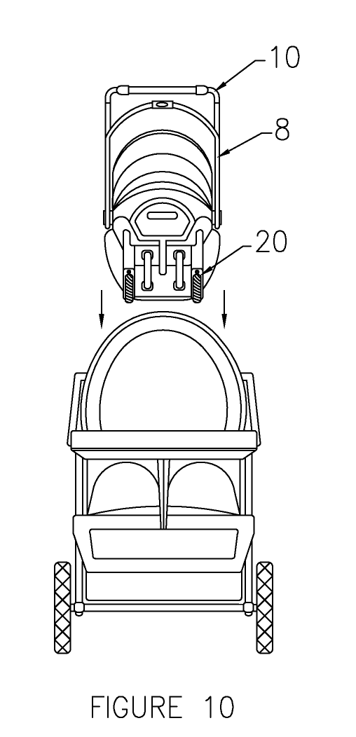

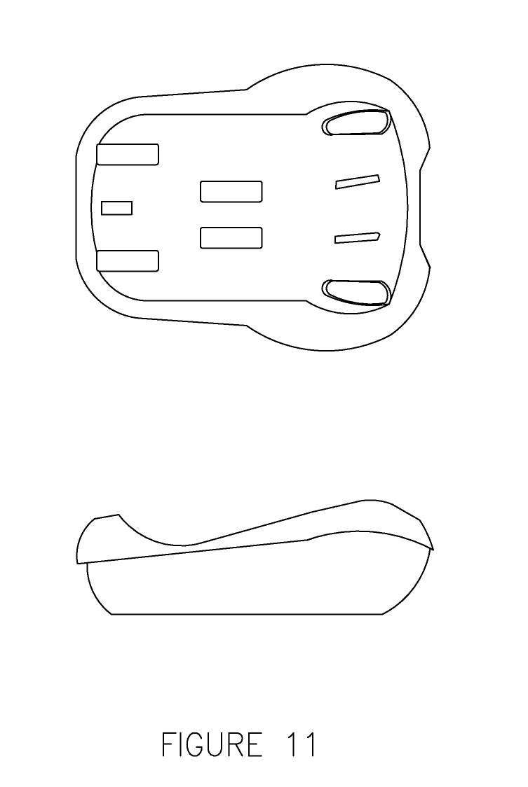

One of the common features of infant car seats is their ability to be moved from the car seat to an infant stroller. With this device the infant car seat can easily be moved from the car seat to a stroller without needing to make any modifications to the stroller such as depicted in FIG. 7.

While the embodiments of the invention have been disclosed, certain modifications may be made by those skilled in the art to modify the invention without departing from the spirit of the invention.

The inventors claim:

1. An infant car seat/stroller combination, which is comprised of:
a. a car seat;
wherein the car seat is of a predetermined shape;
wherein the car seat has a top surface and a bottom surface;
wherein the child is placed on the top surface of the car seat;
said child is secured to interior of the car seat;
b. a car seat handle;
wherein a handle for the car seat is provided;
wherein the car seat handle has two sides and a top surface connected to the two sides;
said car seat handle is connected to the car seat;
said car seat handle is allowed to rotate;
c. a stroller handle;
wherein a stroller handle is provided;
wherein the stroller handle will telescope;
wherein the stroller handle is secured to the car seat handle;
wherein the stroller handle can be locked in place;
d. wheels;
wherein a plurality of wheels will be placed on the back surface of the car seat;
wherein a cavity is provided to house the wheels;
e. means to secure the wheels;
wherein a means to secure the wheels to the car seat are provided;
wherein the means to secure allows the wheels to rotate;
f. brake;
wherein a brake is provided;
said brake prevents the wheels from rotating when the brake touches the wheel;
g. a base;
wherein the base is of a predetermined shape;
wherein the base rests on top of the car seat;
h. means to secure the seat to the base;
wherein a means to secure the seat to the base is provided.

2. The device as described in claim 1 wherein the stroller handle is attached at the same pivot point as the car seat handle.

3. The device as described in claim 1 wherein the stroller handle is secured to the side of the car seat handle.

4. The device as described in claim 1 wherein a cavity is provided in the car seat handle to store the stroller handle.

5. The device as described in claim 1 wherein the means to secure the wheels is a pin.

6. The device as described in claim 1 wherein the means to secure the wheels is an axle.

7. The device as described in claim 1 wherein the means to secure the base to the car seat is a seat belt provided as part of the base.

8. The device as described in claim 1 wherein the means to secure the base to the car seat is a seat belt that is part of the automobile.

9. The device as described in claim 1 which is further comprised of a means to brake the car seat.

10. A means to use an infant car seat/stroller combination, which is comprised of the following steps:
a. placing the car seat on the ground;
b. extending the stroller handle to a predetermined height;
c. grabbing the stroller handle and tilting the car seat backwards a predetermined amount;
d. visually inspecting the brake to make sure that it is not in contact with the wheel of the car seat;
e. maneuvering the car seat by pushing or pulling the stroller handle.
